(19) United States
(12) Patent Application Publication
(10) Pub. No.: US 2004/0105385 A1
(43) Pub. Date: Jun. 3, 2004

(54) Device for accessing a telecommunication network for the selective degradation of data flows

(75) Inventors: Damien Galand, Chaville (FR); Laurent Clevy, Chartres (FR); Olivier Marce, Massy (FR)

Correspondence Address: SUGHRUEMION, PLLC, Suite 800, 2100 Pennsylvania Avenue, N.W., Washington, DC, 20037-3213, US

(73) Assignee: ALCATEL

(21) Appl. No.: 10/721,333

(22) Filed: Nov. 26, 2003

(30) Foreign Application Priority Data
Dec. 2, 2002 (FR) 02 15 126

(51) Int. Cl. H04L 12/26

(52) U.S. Cl. 370/230

(57) ABSTRACT

A device (R_{A}) for accessing a telecommunication network (N) comprising

means for transmitting data flows between at least one first telecommunication client (A) connected to the core network by means of an access network (N_{A}) possessing throughput performances lower than the core network (N) and at least one second telecommunication client (B, S);

degradation means for degrading at least one quality parameter of at least one data flow.

The invention is characterised in that the degradation means make use of a module associated with each session, for carrying out the degradation.

The present invention relates to telecommunication networks, allowing the transmission of multimedia data flows. More precisely, it concerns devices for accessing these telecommunication networks.

The invention applies particularly well to packet switching telecommunication networks, in particular those based on a protocol stack of type IPv4 or IPv6 (Internet Protocol, version 4 or 6, respectively).

One of the advantages of this type of telecommunication network is the ability to easily transport multimedia data flows.

Subsequently, multimedia data flow, or more simply “multimedia flow”, means a set of data transmitted through the network, representing information of diverse natures such as voice, video, text, images, etc.

Within the context of a packet switching network, these data flows are structured in the form of a sequence of packets.

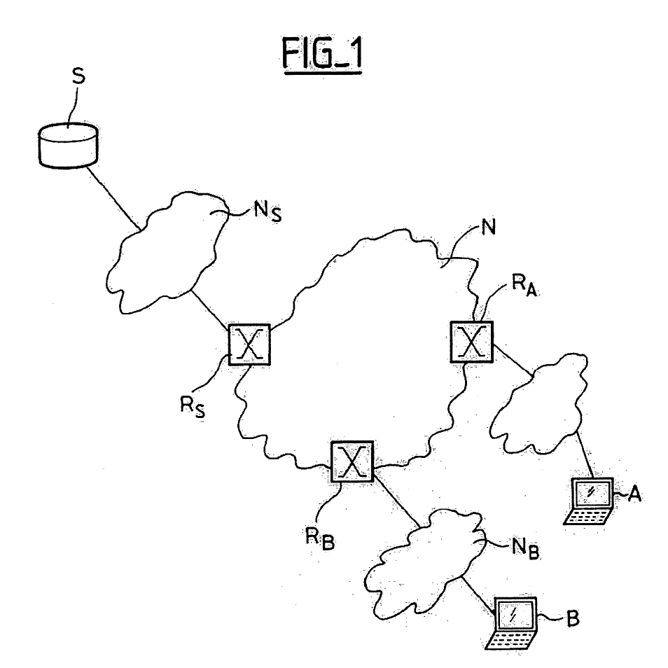

FIG. 1 depicts a telecommunication network N according to the prior art. Clients A, B, S are connected to this network. These clients can be users A, B or service-providing servers S.

Between these various clients, sessions can be established, that is to say information transmissions consequent upon an explicit request from one of the parties. The information transmission may require the establishment of a number of multimedia data flows. For example, in the case of a videoconference, according to one possible embodiment, there can be two multimedia data flows: one flow concerning voice, and one flow concerning video.

These sessions can be established:

between a service-providing server S and a user A, B: this is the case in particular for a VoD (Video on Demand) service;

Between two users A, B: this is the case in particular for a videoconference service.

Each client A, B, S is connected to the network by access devices R_{A}, R_{B}, R_{S}, consisting of one or more network elements (routers, in the case of a telecommunication network based on the protocol stacks IPv4 and/or IPv6), by means of access networks N_{A}, N_{B}, N_{S}.

Conventionally, the transmission capacities of the access networks N_{A}, N_{B} are much lower than those of the main network N. Typically, when the clients A, B are private individual users or small companies, the access networks are the Plain Old Telephone Service (POTS). Even benefiting from xDSL (Digital Subscriber Line) type access technologies, the maximum throughputs possible on the access networks remain lower than the throughputs possible in the Core Network N. This results in the access devices R_{A}, R_{B}, R_{S} being congestion points.

Conversely, the access network Ns is conventionally sufficiently well dimensioned, but it is then in the core network N that congestion can occur when a large number of users are in communication with the service-providing server S. In this situation, it is advantageous to send to the core network N only the data which can be transmitted to the users.

Therefore, the access devices will degrade the transmission of all or certain data flows: This degradation is conventionally done in an arbitrary manner. American patent U.S. Pat. No. 6,434,624 from the Cisco company teaches the application of quality of service processing to certain data flows. This processing is parameterised by policy rules. By nature, therefore, the processing is decided by a central member of the communication network, which cannot have knowledge of the nature of the information conveyed by the data flows.

However, it turns out that the sensitivity to degradation of the data flows depends on the nature of the information they convey.

By way of example, a data flow containing voice is highly sensitive to jitter degradation, but not very sensitive to a reduction in the passband. As for a data flow containing video encoded according to the MPEG (Motion Photographic Expert Group) standard, this is sensitive to loss of packets, since these packets can contain key information for allowing the decoding of subsequent packets: the “P-pictures” are coded from the preceding “I-pictures”, according to a differential coding.

The applicant therefore noted that it was important to take account of the nature of the information conveyed in order to determine:

1. which data flows had to be degraded in preference to the others; and,

2. in what ways they had to be degraded.

To do this, the object of the invention is a device for accessing a telecommunication network comprising

means for transmitting data flows between at least one first telecommunication client connected to the telecommunication network by means of an access network possessing throughput performances lower than the telecommunication network and at least one second telecommunication client accessible through the said telecommunication network, the information flows being organised in sessions, each data flow of one and the same session providing communication between the same telecommunication clients; and

degradation means for degrading at least one quality parameter of at least one of the data flows in order to compensate for the difference in throughputs between the telecommunication network and the access network.

The invention is characterised in that the degradation means make use of a module associated with each session, for carrying out the degradation, this module being determined by the first client.

Thus, the access devices according to the invention allow a degradation of the transmissions of the data flows, belonging to a given session, which is adapted to the nature of the information transmitted.

They have the additional advantage of allowing an adaptation as precise as desired: there can be taken into account not only a classification of the conveyed information into a number of major categories: video, audio, etc., but also the method of encoding this information. This is because the algorithm for coding the information has a very great influence on the impact that degradation of a QoS (Quality of Service) parameter can have on the final quality of the transmitted information.

According to the invention, the module is determined by the first client. This determination can possibly be carried out in cooperation with the end user, in particular by means of configuration parameters.

According to a first embodiment of the invention, the module principally consists of executable code allowing the degradation of the quality parameter or parameters. The module can for example be transmitted in the payload of an active packet transmitted by the first client (A). Alternatively, it can be downloaded from a code server and identified by an identifier contained in an active packet transmitted by the first client.

According to a second embodiment, the module principally consists of a set of tables giving the correspondence, for each data flow of the session, between the quality parameters and the impacts of a degradation of these quality parameters on the quality of the data flow concerned.

According to a third embodiment, the module principally consists of a set of mathematical expressions linking, for each data flow of the session, the quality parameters and the impacts of a degradation of these quality parameters on the quality of the data flow concerned.

According to a fourth embodiment, the module consists of a set of policy rules supplied by a policy server.

Communications with the policy server can for example conform to the CORBA protocol.

The invention and its advantages will emerge more clearly in the following description of non-limiting embodiments, in conjunction with the accompanying figures.

FIG. 1, already commented upon, illustrates the context into which the present invention fits.

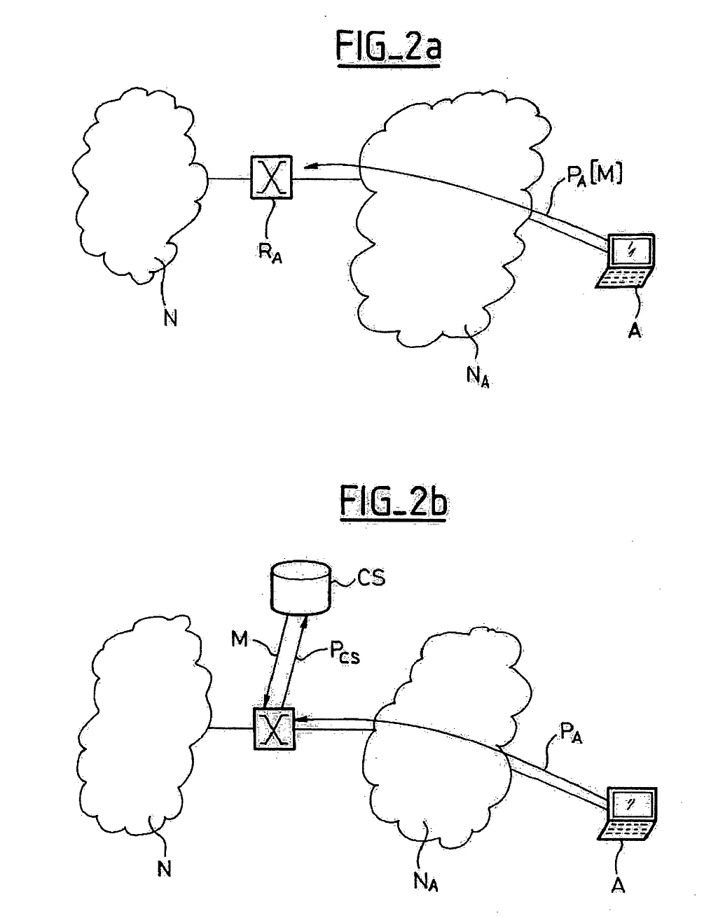

FIGS. 2a and 2b show schematically three possible embodiments of the invention.

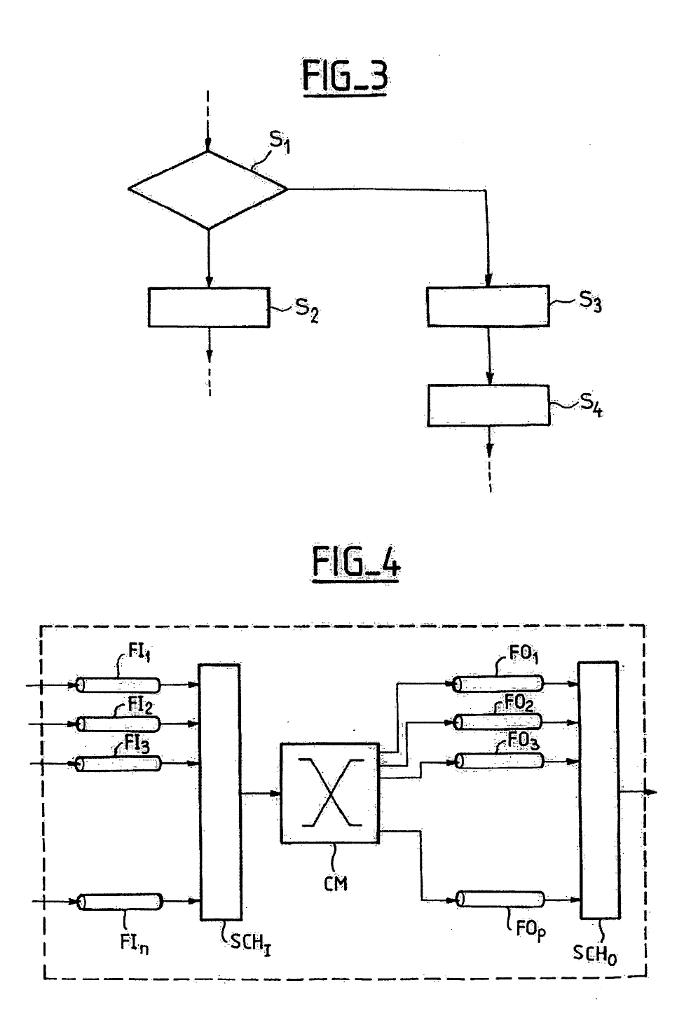

FIG. 3 depicts a flow diagram of the algorithm that can be implemented by the invention.

FIG. 4 illustrates a functional architecture of a router.

FIG. 2a illustrates a first embodiment of the invention using the principle of active networks. Active networks are for example described in the articles:

“Toward an active network architecture” by D. Tennenhouse and D. Wetherall, published in 1996 in the journal Computer Communication Review (26, 2, pages 5 and following).

“Tutorial on Active Networks and its Management” by Marcus Brunner.

The principle of active networks is to give the network elements capabilities for processing executable codes that can be conveyed in the payload of the packets themselves or downloaded from a server and in particular identified by an identifier contained in these packets. The network elements provided with such capabilities are conventionally referred to as “active routers”, and the messages (or packets) containing executable code or an executable code identifier are referred to as “active messages (or packets)”.

According to this first embodiment illustrated by FIG. 2a, the executable code, usually referred to as active code, is conveyed by the packets themselves.

In this example, the telecommunication client A has opened a multimedia session with one (or more) other clients, not depicted in the figure. The access device R_{A} allows the transmission of data flows belonging to this session, between the telecommunication client A by means of the access network N_{A} and the other client (or clients) by means of the telecommunication network N.

The telecommunication client A sends a message P_{A} to the access device R_{A}. This message P_{A} contains a module M consisting of active code. In this example, the access device R_{A} is an active router. It is therefore able to read the active code constituting the module M and load it.

Thus, each time the access device R_{A} needs to reduce one or more quality parameters of one or more data flows, it makes use of the module M thus loaded, associated with the session to which the data flows in question belong. The active code constituting this module M is provided for implementing the degradation process adapted to the session.

According to one embodiment, this module M can take the form of a function (in the conventional procedural programming sense), able to be called by the main software program contained in the access device R_{A}. In particular, this main software program and this function can be written according to a Java™ type language in order to take advantage of the dynamic loading mechanisms of these languages.

Such a function, here called “ReduceBandwidth”, can have as the header:

Function ReduceBandwidth(Flows F1 . . . Fn, quantity q)

The words “Function”, “Flows” and “quantity” are reserved words defining respectively a function, a data type specific to the data flows, and a data type specific for a degradation quantity q. This header can form the interface between the main software program and the loaded function, in order to enable them to cooperate.

An example algorithm schema implemented by the module M can be as illustrated by the flow diagram of FIG. 3.

In a step S₁, it is determined whether one of the data flows constituting the session contains uncompressed data.

If yes, then, in a step S₂, the passband allocated to this data flow is reduced.

If no, then, in a step S₃, for each of the data flows of the session, the impact of a degradation q is evaluated. Then, in a step S₄, the data flow least impacted by this degradation is degraded as a priority.

Of course, other algorithmic schemas are possible. In particular, it is possible to distribute the desired degradation quantity q over a number of data flows rather than impact a single data flow.

A second embodiment of the invention consists of taking advantage of the second mode of implementing the technique of active networks, that is to say transmitting in the active messages an identifier of the active code to be loaded, this possibly being downloaded from a code server. This embodiment is illustrated by FIG. 2b. In FIG. 2b, the access device R_{A} is in communication with a code server CS. The communications between these two elements can be performed by means of the telecommunication network N or by means of a dedicated network. The code server can be common to the different devices for accessing the telecommunication network N (R_{B}, S in FIG. 1, not depicted here). Alternatively, in particular in the case of large telecommunication networks, provision can be made to have a number of code servers CS, possibly communicating with one another in order to synchronise their content.

In this example, the telecommunication client A has opened a multimedia session with one (or more) other clients, not depicted. The access device R_{A} allows the transmission of data flows belonging to this session, between the telecommunication client A by means of the access network N_{A} and the other client (or clients) by means of the telecommunication network N.

The telecommunication client A sends a message P_{A} to the access device R_{A}. This message P_{A} contains information making it possible to determine the desired module. This information can for example be an identifier.

In this case, the identifier can simply be transmitted in a request P_{CS} sent to the code server CS, and directly identify a particular module. The module M can then be downloaded to the access device R_{A}.

Loading and interfacing of the active code constituting the module M can be performed in a manner identical or similar to that indicated for the first embodiment. The algorithmic schemas can also be identical.

According to another embodiment of the invention, the module M does not consist of active code but of a table, associated with each data flow constituting the session, giving the correspondence between the different quality parameters and the impact of a degradation of this parameter on the quality of the data flow.

For example, for a data flow conveying uncompressed voice (for example for a Voice Over IP or VoIP application), such a correspondence table may contain the following information:

| | |
|---|---|
| Jitter | 3 |
| Packet loss | 2 |

The second column indicates in numerical form from 0 to 3 the impact of degradation of the corresponding quality parameter, a high figure indicating a large impact. It can be seen in this example that a jitter degradation (that is to say the variation in the gaps between two successive messages of the data flow) is much more significant than a passband degradation.

In the same way, such a correspondence table for a data flow conveying video compressed according to an MPEG (Motion Photographic Expert Group) compression algorithm may contain the following information:

| | |
|---|---|
| Packet loss | 3 |
| Jitter | 1 |

It can be seen in this example that packet loss is a quality parameter whose degradation has a high impact on the resultant quality, as opposed to jitter.

This is because, as mentioned previously, certain packets can contain information essential to the decompression of subsequent packets: certain fixed images constituting video are coded differentially with respect to key images. Therefore, the loss of packets containing these key images can prevent reconstruction of the subsequent “differentially” coded images.

For a multimedia session comprising these two data flows, the access device R_{A} is able to choose the strategy minimising the impact of the necessary degradation.

It can for example sum the impacts of each quality parameter in the correspondence tables of the data flows of the multimedia session. It then obtains:

| | |
|---|---|
| Packet loss | 5 |
| Jitter | 4 |

As the impact of packet loss is greater, it can choose a strategy consisting of increasing the jitter, that is to say in concrete terms, of letting the queues inside the access device grow.

Another strategy consists of differentiating the data flows within one and the same session. Thus, it can favour packet loss for the data flow conveying voice or uncompressed data, and on the contrary favour increasing jitter for the data flow conveying MPEG compressed video. Of course, these examples are given only as a guide, and the parameters considered in the first column can have much more precise semantics. For example, it can be the loss of packets containing data of a “P-picture” in the case of MPEG data.

It is furthermore possible to introduce weighting associated with the data flows of one and the same session. For example, by setting a greater degradation impact value for audio, this will have the consequence of giving greater importance to audio.

According to another embodiment of the invention, the module M principally consists of a set of mathematical expressions linking the quality of each data flow constituting the session with different quality parameters.

The overall quality qᵢ of each data flow i can be expressed in the form:

$${q}_{i} = {\sum }_{j = 1}^{n} {α}_{j} \cdot {p}_{j}$$

in which n is the number of quality parameters and αⱼ is the impact of the quality parameter pⱼ on the overall quality qᵢ.

According to a variant, this mathematical formula can be expressed in the form of a vector (α₁, α₂, α₃ . . . αₙ). This formulation has the merit of allowing a practical transmission, in a message P_{A}, which is easier and gets closer to the third embodiment. It is however less flexible than the use of a mathematical expression since it allows only the expression of linear dependencies between the quality parameters pⱼ and the overall qualities qᵢ.

The access device R_{A}, having knowledge of the mathematical expressions (in formula form or in vector form), can implement different strategies in order to minimise the overall impact of the degradation. These strategies are similar to those described previously for the third embodiment.

According to another embodiment of the invention, the information necessary for selective degradation of one of the data flows of a session is available on a policy server.

This policy server can typically be a Policy Decision Point (PDP), as described in RFC 2748 of the IETF.

In this situation, the access device R_{A} acts as a Policy Enforcement Point (PEP), and it asks the policy server (PDP) for the rules to be implemented for degradation of the flows of one and the same session.

These rules can be requested either preventatively, for example during start-up of the access device or at regular intervals, or else on command of an external management station, etc., or reactively, for example upon establishment of a session or when congestion is detected.

The access device and the policy server can conform to the CORBA (Common Object Request Broker Architecture) software architecture of the OMG (Open Management Group). The communications between the access devices and the policy server can also conform to this CORBA protocol.

The access device R_{A} can typically consist of one or more network elements, in particular IP routers.

FIG. 4 illustrates an example functional architecture of an IP router.

An IP router is structured around a switching matrix CM to which there are connected a set of input queues FI₁, FI₂, FI₃ . . . FIₙ and a set of output queues FO₁, FO₂, FO₃ . . . FOₚ. Two schedulers SCH_{I} and SCHₒ have the function of determining the order of processing of the queues, respectively input and output.

The module M can then be loaded within these schedulers in order to modify their queue processing policy.

Furthermore, in certain situations, the determination of the final quality of the transmitted information is subjective, that is to say only (or more easily or precisely) able to be judged by a human being.

Therefore, the client application A can determine the appropriate module M, in cooperation with the end user or users. This cooperation can take the form of software configuration parameters of the client application A.

1. A device (R_{A}) for accessing a telecommunication network (N) comprising
means for transmitting data flows between at least one first telecommunication client (A) connected to the said telecommunication network by means of an access network (N_{A}) possessing throughput performances lower than the said telecommunication network (N) and at least one second telecommunication client (B, S) accessible through the said telecommunication network (N), the said information flows being organised in sessions, each data flow of one and the same session providing communication between the same telecommunication clients; and
degradation means for degrading at least one quality parameter of at least one of the said data flows in order to compensate for the difference in throughputs between the said telecommunication network and the said access network,
characterised in that the said degradation means make use of a module associated with each session, for carrying out the said degradation, the said module being determined by the said first client (A).

2. An access device according to claim 1, in which the said module principally consists of executable code allowing the degradation of the said at least one quality parameter.

3. An access device according to claim 2, in which the said module is transmitted in the payload of an active packet transmitted by the said first client (A).

4. An access device according to claim 2, in which the said module is downloaded from a code server and identified by an identifier contained in an active packet transmitted by the said first client.

5. An access device according to claim 1, in which the said module principally consists of a set of tables giving the correspondence, for each data flow of the said session, between the quality parameters and the impacts of a degradation of these quality parameters on the quality of the said data flow.

6. An access device according to claim 1, in which the said module principally consists of a set of mathematical expressions linking, for each data flow of the said session, the quality parameters and the impacts of a degradation of these quality parameters on the quality of the said data flow.

7. An access device according to claim 1, in which the said first client determines the said module in cooperation with the end user, in particular by means of configuration parameters.

8. An access device according to claim 1, in which the said module consists of a set of policy rules supplied by a policy server.

9. An access device according to the preceding claim, in which the communications with the policy server conform to the CORBA protocol.
